(19) United States
(12) Patent Application Publication
(10) Pub. No.: US 2004/0139617 A1
(43) Pub. Date: Jul. 22, 2004

(54) Blades for electric knife

(76) Inventors: Mike Neshat, Jonesboro, AR (US); Ted Thompson, Imboden, AR (US)

Correspondence Address: Dennis B. Haase, Post Office Box 3592, Little Rock, AR, 72203, US

(21) Appl. No.: 10/342,525

(22) Filed: Jan. 16, 2003

(51) Int. Cl. B26B 9/02

(52) U.S. Cl. 30/355

(57) ABSTRACT

A blade assembly primarily, although not exclusively, for use in concert with a power handle to fillet game and/or fish in which a pair of matched opposed blades make up the assembly, and wherein each blade is especially thin relative to its length; a portion of the blade above the teeth being removed to minimize the frictional resistance offered by the assembly in use, and all sharp corners being tapered and/or rounded to reduce the danger of accidents during use.

The present invention relates to knife blades primarily, although not exclusively, for use with an electric knife and, more particularly, to such blades which have been specially adopted to the needs of sportsmen who wish to fillet game and fish in the field.

### BACKGROUND OF THE INVENTION

1. Field of the Invention

While there is seemingly an inexhaustive array of cutting instruments available for almost any imaginable purpose, not all of these devices are effective for their intended purpose.

Years of experience in the use of, as well as the marketing of, knives, and, more recently, electric knives, some of which are capable of being battery operated for field use, has demonstrated a need for a longer than standard blade for field use which would expedite filleting of large fish and edible game with the same efficiency and expediency achieved with smaller blades under the same field conditions.

With an increase in length comes an increase in the need for special design parameters to overcome the difficulties attendant a longer blade. Such difficulties tend to multiply when the blade is used with a powered knife handle, and it is in this context that the blade of the present invention was developed and perfected.

2. Overview Of The Prior Art

Perhaps, at least in terms of the cutting edge, my copending application Ser. No. 10/159,941, filed Jun. 3, 2002, is an appropriate starting point as representation of the state of the art, over which the present invention provides a significant advance. In terms of the special features that distinguish the present invention, no peer in the art is known.

### SUMMARY OF THE PRESENT INVENTION

The present invention provides to the sportsman a unique tool for facilitating, for example, the skinning of game and/or the filleting of fish and game by creating, in conjunction with a power handle, an exceptionally thin pair of matched cutting blades, relative to their length, which itself is elongated to permit larger cutting strokes in an efficient and facile manner.

It is, broadly, therefore, an objective of the present invention to provide the user with an elongate blade assembly which, in concert particularly with a power handle, facilitates the removal of meat from game and/or fish.

As an adjunct to the foregoing objective, the present invention provides such a blade assembly which is also especially safe in use.

A further objective is to provide a cutting blade assembly, primarily for use in conjunction with a power handle, and especially a battery operated power handle, which has particular utility to sportsmen in the field wherein game, and/or fish may be reduced to the edible products thereof quickly and with considerable safety and ease, reduces frictional drag, and in so doing, minimizes the drain on the available battery power in the handle, where battery driven, and the drain on the power source where it is not.

Other and further benefits and objectives to be accomplished by the present invention will become apparent to those skilled in the art when the Detailed Description of The Present Invention is read in conjunction with the accompanying drawings, wherein:

### BRIEF DESCRIPTION OF THE DRAWINGS

FIG. 1 is a perspective view of an assemblage of blades constructed in accordance with the present invention, and having particular utility when used in conjunction with a power handle, not shown;

FIG. 2 is a top plan view of the blade assembly of FIG. 1;

FIG. 3 is a side elevation of the blade assembly of FIG. 1;

FIG. 4 is a partial sectional view of FIG. 3, taken along lines 4-4 thereof, and illustrating the interrelationship of the grease guards and the blades to which they attach;

FIG. 5 is an exploded view of the blade assembly of FIG. 1, illustrating, in some detail, the manner in which the various parts of the blade assembly interface and come together to form a unit;

FIG. 6 is a partial sectional view of the blade assembly of FIG. 1, showing some of the safety and other utilitarian features of the blades of the present invention, with the outer blade moved to its forward position relative to the inner blade; and,

FIG. 7 is a view similar to FIG. 6, with the inner blade in its most forward position relative to the outer blade of the present invention.

### DETAILED DESCRIPTION OF A PREFERRED EMBODIMENT

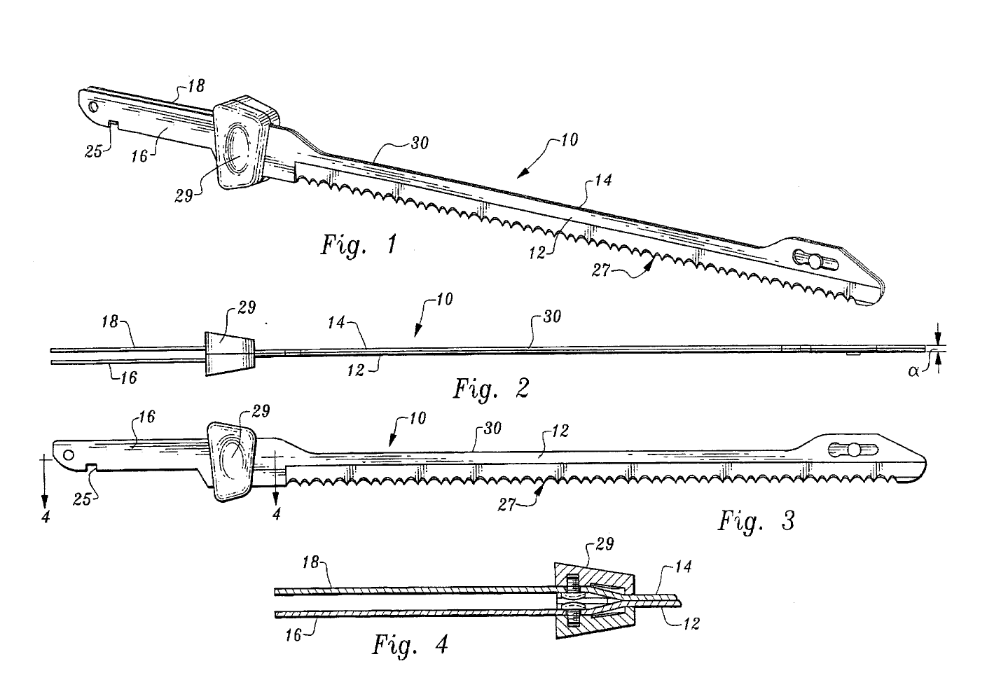

With reference now to the drawings, and initially to FIG. 1, a blade constructed in accordance with the present invention, and capable of forming a powered assemblage with a like blade, such an assemblage being shown, and denominated as 10.

With reference next to FIGS. 2 and 3, it will be seen that the blade assembly 10 comprises a matched pair of opposed blades 12 and 14. It will be readily appreciated, however that the blade has similar advantages when used manually as a single blade.

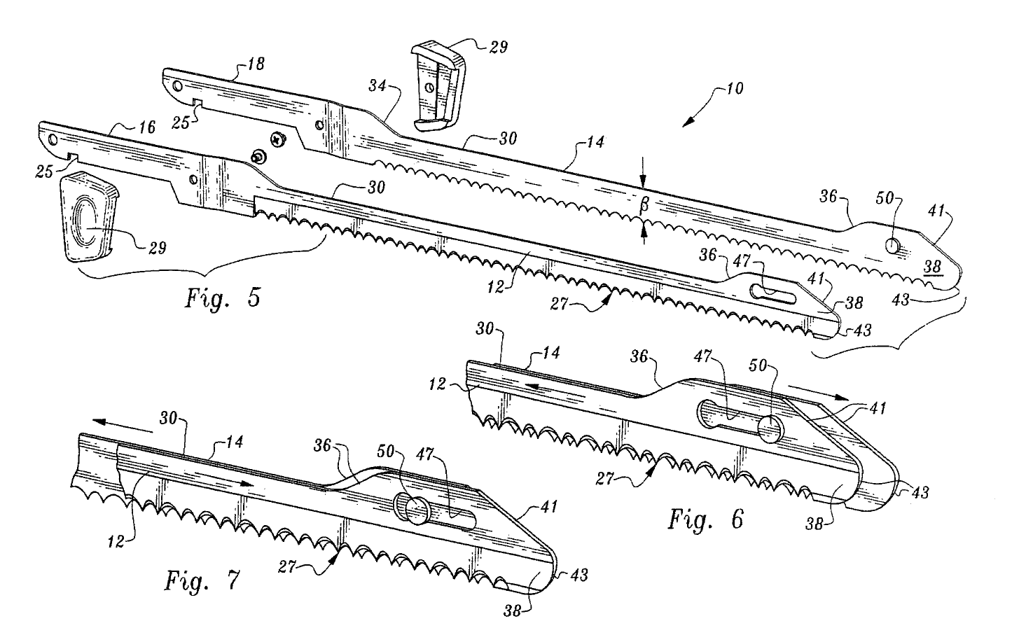

Each of the blades 12 and 14 are formed with a tang 16 and 18 at the rear of a cutter section 21 and 23, perhaps best seen in FIG. 5. The tang and cutter section are formed along a common longitudinal axis The tangs are notched as at 25 and are shaped to fit snugly in any standard electric knife power handle (well known in the art, and thus, not shown). The lower edge of each cutter section is formed with a series of contiguous teeth 27, the configuration of which is the subject of my copending application, and the cutter sections and the tangs on each blade are separated by a grease guard 29.

Directing the focus now to the blade sections 21 and 23, it is a novel feature of the present invention that the thickness of each cutter section is ½ α (FIG. 2) and is slight relative to the length of the cutter section 21, 23.

By way of illustration, for a cutter section which is a straight edge and being 10″ in overall length, the α dimension is 0.100″ or 0.050″ per blade. The blade of the present invention demonstrates an uncommon capacity to meet the objectives established for it when the α dimension is within a range of 0.045 to 0.060. Tests demonstrate that a thicker blade may penetrate the rib cage or bone structure of the edible being filleted, and a thin blade would be deflected by it.

The α dimension is such that, in accordance with the objectives of the invention, it permits the user to accurately carve edibles from the bones of game and/or fish with minimal drag on the blades, even with a lengthy blade where a more thickened dimension is generally regarded as necessary to avoid undesirable flexing of the blades.

It is a further objective of the present invention to create a blade that offers minimal resistance as it cuts through edibles. It is understood by those skilled in the art that frictional resistance is to some extent a function of the surface area of the blade which is in intimate contact with the game or fish to be filleted. As a compliment, therefore, to the thinness of the blades, material has been removed in the plane of the blade along its longitudinal axis to substantially reduce that resistance offered by the blade during use, but without sacrifice to strength of the blade.

In further accomplishment of this laudable objective, the thickness of the cutter section is reduced by removing an elongated material along the edge opposite the teeth thereof. Thus, the upper edge 30 of each blade 12 and 14 is notched, or indented, above the teeth of the cutter section in the plane of the blade, so as to create a narrowing of the overall height of the cutter section of each blade to a dimension β, and, accordingly, there is a resultant reduction in surface area in contact with the edibles being filleted. In consequence of that reduction, the load on the power supply is proportionateley reduced.

In creating the narrowing of the cutting section in a safe and visually pleasing manner, the indentation culminates in an aft, downwardly soft, curved surface 34 being at the full height of the blade in the area of the grease guards 29 and toward the cutter section, thus creating the thickness β and a corresponding forward upwardly curved surface 36 is created at the forward portion of the section to the full thickness of the blade once again. The significantly reduced surface area of the blade has the dual effect of reducing frictional resistance in the filleting process, as well as allowing the motor when used in an electric knife to run cooler. Further, the thinner blade makes maneuvering around boney matter easier and such things as the nugget in a catfish more easily excised.

As an added safety measure, the nose 38 of each blade is first beveled as at 41 and melds into a rounded tip 43. As a result of this construction, there are no sharp edges or corners to catch on clothing or nick fingers, making the blade of the present invention one of the safest to use in its class.

Finally, to insure proper interaction of the blades 12 and 14, the blade 12 is formed with a channel 47 which runs for a predetermined distance in a direction which is coaxial with the axis of the blade. A rivet 50 disposed on the other blade 14, engages, and rides in, the channel 47 as the blades are reciprocated by the power handle.

Having thus described, in some detail, a preferred embodiment of the present invention, and with the clear understanding that minor modifications will occur to those skilled in the art, all of which are within the contemplation of the invention, the following claims are presented:

1. A blade for use with a handle, to form a knife, comprising:
an elongate blade; said blade being thin relative to its length;
each said blade including a cutter section; said cutter section having upper and lower edges along its length; teeth formed along one edge of said cutter section, the width of said cutter section being narrowed in a plane transverse to the longitudinal axis of said blade to thereby minimize surface area of the blade against edibles being cut thereby.

2. The blade as set forth in claim 1, wherein said blade has a thickness of 0.050″.

3. The blade as set forth in claim 1, wherein said blade has a thickness range between 0.045″ and 0.060″.

4. The blade as set forth in claim 1, wherein the ratio of the thickness of said blade relative to its length is 200 to 1.

5. The blade as set forth in claim 1, wherein the ratio of the thickness of each blade relative to its length is between 222.2 and 1.667 to 1.

6. The blade as set forth in claim 1, wherein said lower edge of said cutter section is straight and parallel to the axis of said blade.

7. The blade as set forth in claim 1, wherein each blade has a thickness of 0.050″, said lower edge of said cutter section being straight and parallel to the axis of said blade.

8. The blade as set forth in claim 1, wherein said blade has a thickness range between 0.045″ and 0.060″, said lower edge of said cutter section being straight and parallel to the axis of said blade.

9. The blade as set forth in claim 1, wherein the ratio of the thickness of each blade relative to its length is between 222.2 and 1.667 to 1, said lower edge of said cutter section being straight and parallel to the axis of said blade.

10. A blade assembly for use with a handle, to form a knife, comprising:
an elongate blade; said blade being thin relative to its length;
each said blade including a cutter section; said cutter section having upper and lower edges along its length; teeth formed along one edge of said cutter section, the width of said cutter section being narrowed in a plane transverse to the longitudinal axis of said blade to thereby minimize surface area of the blade against edibles being cut thereby.

11. The assembly as set forth in claim 10, wherein said blade has a thickness of 0.050″.

12. The assembly as set forth in claim 10, wherein said blade has a thickness range between 0.045″ and 0.060″.

13. The assembly as set forth in claim 10, wherein the ratio of the thickness of said blade relative to its length is 200 to 1.

14. The assembly as set forth in claim 10, wherein the ratio of the thickness of each blade relative to its length is between 222.2 and 1.667 to 1.

15. The assembly as set forth in claim 10, wherein said lower edge of said cutter section is straight and parallel to the axis of said blade.

16. The assembly as set forth in claim 10, wherein each blade has a thickness of 0.050″, said lower edge of said cutter section being straight and parallel to the axis of said blade.

17. The assembly as set forth in claim 10, wherein said blade has a thickness range between 0.045″ and 0.060″, said lower edge of said cutter section being straight and parallel to the axis of said blade.

18. The assembly as set forth in claim 10, wherein the ratio of the thickness of each blade relative to its length is between 222.2 and 1.667 to 1, said lower edge of said cutter section being straight and parallel to the axis of said blade.
